(19) United States
(12) Patent Application Publication
(10) Pub. No.: US 2017/0068644 A1
(43) Pub. Date: Mar. 9, 2017

(54) SYSTEMS, DEVICES, AND METHODS FOR DYNAMICALLY GENERATING WEBPAGES

(71) Applicant: BlogNirvana.com, LLC, Boise, ID (US)

(72) Inventors: Nicholas Allen Jones, Boise, ID (US); Peter James Wachtell, Boise, ID (US)

(21) Appl. No.: 15/095,681

(22) Filed: Apr. 11, 2016

Related U.S. Application Data
(60) Provisional application No. 62/215,947, filed on Sep. 9, 2015.

(51) Int. Cl. G06F 17/21; G06Q 30/02; G06F 17/22

(52) U.S. Cl. CPC G06F 17/212; G06F 17/2247; G06F 17/2205; G06F 17/2288; G06Q 30/0277

(57) ABSTRACT

Embodiments relate to systems, devices, and computing-implemented methods for dynamically generating, at a website server, a webpage based on client device information received from the client device and transmitting the webpage to the client device. A dynamic content slot in the webpage can be filled, by the website server, based on receiving a request from the client device, and dynamic content can be obtained and transmitted to the client device. Dynamic content slots can be filled, at least in part, based on client device information and a first client device can receive different dynamic content than a second client device. Thus, the website server can control the dynamic content that appears on the website and, by sending the dynamic content via the website server, browsers of the client devices can identify the dynamic content as actual website content of the webpage.

### CROSS-REFERENCE TO RELATED APPLICATIONS

This application claims the benefit of U.S. Provisional Application No. 62/215,947 filed on 9 Sep. 2015, which is hereby incorporated by reference in its entirety.

### BACKGROUND

Website servers operate by receiving Hypertext Transfer Protocol (HTTP) requests, and sending HTTP responses that include documents and/or instructions for rendering a webpage. Generally, the webpages include actual website content items, such as text, images, video, etc. Content items are typically static. In other words, different client devices that render a webpage will render the same content items. Additionally, in some instances, webpages can include dynamic content items.

In some cases, dynamic content items can include, for example, website advertisements. For example, a webpage can include an ad tag, which instructs a browser on a client device to retrieve an advertisement item from an advertisement network that is separate from the website server that manages and/or stores the webpage. The ad tag can include criteria, and the advertisement network can send an advertisement item that matches the criteria. However, the advertisement item sent to a first client device that renders a webpage can be different from the advertisement item sent to a second client device that renders the same webpage.

Content filtering applications, such as ad blocking browser extensions, are able to determine types of content (e.g., advertisement items) and, in some instances, filter content before it is rendered on the browser. Additionally, ad blocking browser extensions are able to distinguish between actual website content and advertisement items on a webpage and prevent advertisements from displaying when the webpage is rendered. For example, ad blocking browser extensions can identify advertisements based on the ad tags in the HTTP response. As an additional example, many advertisements may use standard sizes (e.g., 80 by 650 pixels) and, thus, ad blocking browser extensions can identify some advertisements based on their size.

Therefore, for at least these reasons, website server operators are unable to control and/or monitor the website content that is actually presented to end users. Thus, there is a desire for systems, methods, and devices that provide for dynamically created webpages with dynamic content that will not be removed by content filtering application and that is capable of being monitored by the website server that provides the webpage.

### SUMMARY

The present disclosure relates to systems, devices, computer readable storage medium, and methods for providing dynamic website content by receiving, from a client device, a request to access a webpage associated with an address, the request including client device information; generating the webpage with a dynamic content slot based on the client device information; transmitting the webpage to the client device; receiving an asynchronous request to fill the dynamic content slot based on a determination by the client device that the webpage was missing an item; transmitting a request for instructions associated with the dynamic content slot; obtaining an item in response to the request for instructions; and transmitting the item to the client device.

The present disclosure also relates to systems, devices, computer readable storage medium, and methods for providing dynamic website content by receiving, from a website server, a first request for instructions associated with a dynamic content slot associated with a webpage; determining to fill the dynamic content slot with a first item; transmitting instructions corresponding to the first item to the website server where the website server transmits a webpage to a first client device, the first client device renders, in a browser, website content within the webpage comprising the first item in the dynamic content slot, and the browser identifies the first item as actual website content of the webpage; receiving, from the website server, a second request for instructions associated with the dynamic content slot associated with the webpage; determining to fill the dynamic content slot with a second item; transmitting instructions corresponding to the second item to the website server where the website server transmits a webpage to a second client device, the second client device renders, in a browser, website content within the webpage comprising the second item in the dynamic content slot, and the browser identifies the second item as actual website content of the webpage.

### BRIEF DESCRIPTION OF THE DRAWINGS

The accompanying drawings, which are incorporated in and constitute a part of this specification, illustrate various embodiments of the present disclosure and together, with the description, serve to explain the principles of the present disclosure. In the drawings:

FIG. 1 is a diagram illustrating an example webpage distribution network, consistent with certain disclosed embodiments;

FIG. 2 is a flow diagram illustrating an example process for synchronously providing dynamically generated webpages, consistent with certain disclosed embodiments;

FIG. 3 is a flow diagram illustrating an example process for synchronously requesting dynamically generated webpages, consistent with certain disclosed embodiments;

FIG. 4 is a flow diagram illustrating an example process for asynchronously providing dynamically generated webpages, consistent with certain disclosed embodiments;

FIG. 5 is a flow diagram illustrating an example process for asynchronously requesting dynamically generated webpages and dynamic website content;

FIG. 6 is a flow diagram illustrating an example process for providing dynamic website content and comparing metrics associated with dynamic website content, consistent with certain disclosed embodiments;

FIG. 7 is a flow diagram illustrating an example process for dynamic content caching at a website server, consistent with certain disclosed embodiments;

FIG. 8 is a flow diagram illustrating example communications in a webpage distribution network, consistent with certain disclosed embodiments;

FIG. 9A is a diagram illustrating an example webpage generated using dynamic content slots, consistent with certain disclosed embodiments;

FIG. 9B is a diagram illustrating an example webpage generated using dynamic content slots, consistent with certain disclosed embodiments; and

FIG. 10 is a diagram illustrating an example of a hardware system that can be used in a webpage distribution network, consistent with certain disclosed embodiments.

### DETAILED DESCRIPTION

The following detailed description refers to the accompanying drawings. Wherever convenient, the same reference numbers are used in the drawings and the following description to refer to the same or similar parts. While several examples of embodiments and features of the present disclosure are described herein, modifications, adaptations, and other implementations are possible, without departing from the spirit and scope of the present disclosure. Accordingly, the following detailed description does not limit the present disclosure. Instead, the proper scope of the disclosure is defined by the appended claims.

In some embodiments, a website server can maintain a website by storing webpage documents. The webpage can include code (e.g., HTML, Javascript, etc.) that instructs a browser how to render a webpage for display. Additionally, the webpage documents can include, for example, actual website content, which can be text, images, video, etc. that make up the information that is presented to a user. As used herein, the actual website content includes the information that draws the user to the webpage, and the entity that controls the website server controls the actual website content.

The webpage documents can also include, for example, ad tags, which instruct browsers to retrieve and display advertisement items from an advertisement network that is separate from the website server. In conventional processes, the ad tags cause the browsers to directly retrieve advertisement items from the ad network servers, and the advertisement items do not pass through the website server. However, using such conventional processes, website servers lack the technically ability to fully control or monitor what advertisements or other types of dynamic content appear on the webpage.

Additionally, many website visitors view advertisements as an annoyance. Accordingly, many website visitors utilize content filtering applications, such as ad blocking browser extensions, to filter out advertisements and, thus, prevent advertisements from rendering on webpages. Therefore, using conventional processes, website servers have even less control over and are unable to monitor the final appearance of the webpage because the website servers lack the technical ability to present advertisements or other types of dynamic content that are immune to content filtering applications.

These are significant technical problems faced when running a website because, despite all the time and effort put into designing the appearance of a website, using conventional processes, the final appearance of a webpage within a browser on a client device is not under the control of the website server.

Accordingly, in some embodiments, website servers can control the final appearance of a webpage using a coordinating layer, operating on the website server, that retrieves dynamic content items from ad networks and adds the dynamic content items to the webpage as actual website content, as explained in further detail below. Thus, the website server has full control over and is able to monitor the actual final appearance of the webpage because the website server directly adds the dynamic content items to the webpage as actual website content. Additionally, the dynamic content items are immune to content filtering applications that remove advertisements because, using such a process, the advertisements appear as actual website content, as explained in further detail below. Various embodiments described herein and consistent with the present invention solve these technical problems, among others.

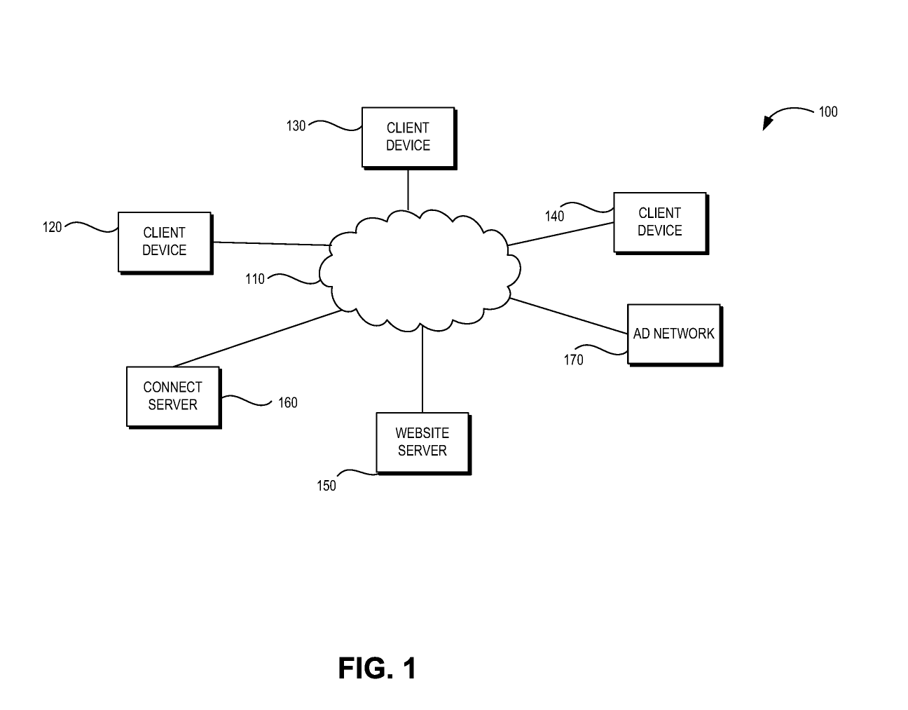

FIG. 1 is a diagram illustrating an example webpage distribution network, consistent with certain disclosed embodiments. In some embodiments, distribution network 100 can include communication network 110, client device 120, client device 130, client device 140, website server 150, connect server 160, and ad network server 170.

In some embodiments, communication network 110 can represent any type of one or more wired and/or wireless telecommunications networks. For example, communication network 110 can represent the Internet and/or one or more telephone networks, one or more cellular networks, one or more local area networks (LANs), etc. In some implementations, computing devices, such as, for example, client devices 120-140 can connect to, for example, website server 150 via communication network 110. In further implementations, website server 150 and/or connect server 160 can connect to, for example, ad network server 170 via communication network 110.

In some embodiments, client devices 120-140 can each represent one or more computing devices. For example, client devices 120-140 can represent one or more personal computers (e.g., desktop and/or laptop devices), one more or mobile devices (e.g., smartphone, tablet, and/or smartwatch devices), etc. used to run a browser application that can render and display webpages. In some embodiments, one or more of client devices 120-140 can additionally run a content filtering application as an extension of the browser application.

In some implementations, website server 150 can represent one or more computing devices. For example, website server 150 can represent database servers, mainframe computers, etc. used to store and/or distribute webpages of a website. In some embodiments, a website server 150 can process requests via HTTP, run content management system (CMS) software, and/or run coordinating layer software (e.g., as an extension of the CMS). Accordingly, website server 150 can receive HTTP requests from client devices (e.g., client devices 120-140) and provide HTTP responses with webpage documents that cause the client devices to render webpages. Additionally, in some implementations, website server 150 can utilize the coordinating layer to retrieve advertisement items (e.g., from ad network server 170 via connect server 160), retrieve dynamic content items, retrieve instructions corresponding to dynamic content items, add the dynamic content items to the webpage as actual website content (e.g., using the CMS), and/or transmit the dynamic content items and/or webpages that include the dynamic content items to client devices.

In some embodiments, connect server 160 can represent one or more computing devices. For example, connect server 160 can represent a database server, web server, mainframe computer, etc. used to communicate with website servers and ad networks. In various embodiments, connect server 160 can be associated with the coordinating layer software running on one or more website servers (e.g., website server 150). Thus, the coordinating layer software can send advertisement criteria, client device information, and/or website server information to connect server 160, and connect server 160 can select ad networks (e.g., ad network server 170) for retrieving advertisement items. Connect server 160 can then transmit advertisement items to website servers (e.g., website server 150) via the coordinating layer. In some embodiments, connect server 160 can also alter the advertisement items to avoid content filtering applications, as discussed in further detail below.

In some embodiments, ad network server 170 can represent one or more computing devices. For example, ad network server 170 can represent a database server, web server, mainframe computer, etc. used to store and distribute advertisement items. In various embodiments, advertisement items can be, for example, text, images, video, animations, hyperlinks, etc. that can be presented on a webpage. In some embodiments, ad network server 170 can select from among stored advertisement items based on advertisement criteria, such as, for example, geographic limitations, subject matter limitations, size limitations, ad dimensions, and/or media type limitations, etc. In various embodiments, requests for advertisement items and/or advertisement criteria can be received from, for example, client devices (e.g., client devices 120-140), website servers (e.g., website server 150), and/or connect servers (e.g., connect server 160). Ad network server 170 can respond to requests for advertisement items and/or advertisement criteria by transmitting one or more selected advertisement items to the requesting device.

The schematic depicted in FIG. 1 is merely for the purpose of illustration and is not intended to be limiting. Further, the webpage distribution network depicted is merely a simplified example of a webpage distribution network, consistent with certain disclosed embodiments, but such an example is not intended to be limiting. For example, in various embodiments, the webpage distribution network can include additional networks, client devices, website servers, connect servers, ad network servers, and/or other devices. Additionally, the described devices can be separate devices, as pictured, or various devices can be combined, consistent with certain disclosed embodiments. For example, in some embodiments, connect server 160 can be part of and/or associated with website server 150. As an additional example, in some embodiments, connect server 160 can be part of and/or associated with ad network server 170.

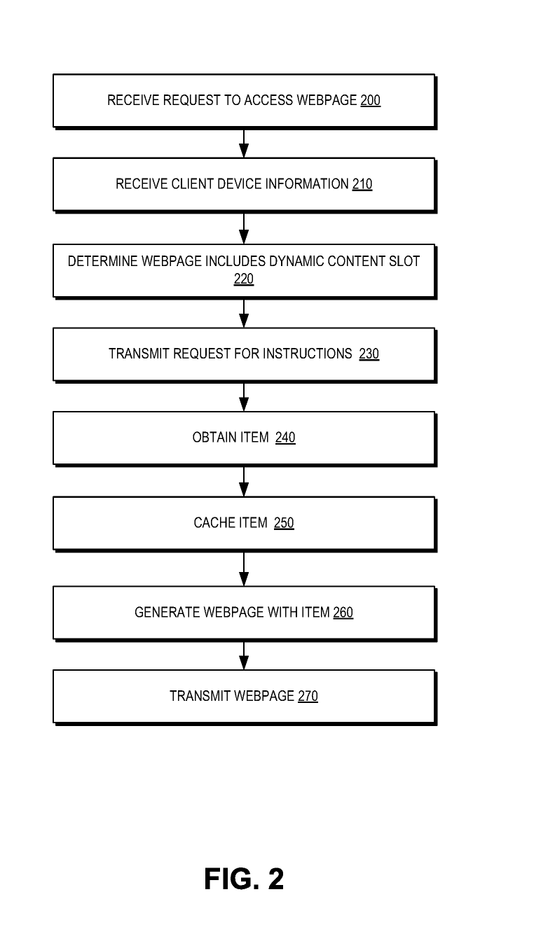

FIG. 2 is a flow diagram illustrating an example process for synchronously providing dynamically generated webpages, consistent with certain disclosed embodiments. In some embodiments, the method described in FIG. 2 can be performed using a computing device or one or more computing devices such as, for example, a database server, a web server, a mainframe computer, etc. For example, the method described in FIG. 2 can be performed by website server 150 in FIG. 1.

In some embodiments, the computing device can be running a CMS and a coordinating layer program (e.g., as an extension of the CMS).

The process can begin in 200, when the computing device receives a request to access a webpage from a client device (e.g., client device 120-140 in FIG. 1). In various embodiments, the request can be an HTTP request and can include a Uniform Resource Identifier (URI) that identifies a document associated with the webpage that is being requested.

In 210, the computing device can receive client device information from the client device (e.g. client device 120-140 in FIG. 1). For example, the client device information can include, but is not limited to, an Internet Protocol (IP) address associated with the client device, a geographic location associated with the client device (e.g., based on the Internet Service Provider (ISP) of the client device), browser cookie information of the client device (e.g., information regarding previous browsing activity of the client device), etc.

In some embodiments, the client device information can be received in the same communication as the request to access the webpage in 200, while, in further embodiments, the client device information can be received as a separate communication.

In 220, the computing device can determine that the requested webpage includes at least one dynamic content slot. In various embodiments, a dynamic content slot can be used to add dynamic content to a webpage, as described in further detail below. In some embodiments, a dynamic content slot can allow the computing device to dynamically generate webpages such that a webpage sent to a first client device (e.g., client device 120 in FIG. 1) can be different from a webpage sent to a second client device (e.g., client device 130 in FIG. 1).

In some embodiments, the dynamic content slot can be HTML, JavaScript, and/or other types of code that can be identified by the computing device using the coordinating layer. For example, the dynamic content slot may have been automatically inserted by the coordinating layer or manually inserted using the coordinating layer. In further embodiments, the dynamic content slot can be code that was not inserted directly by coordinating layer, such as, for example, an ad tag.

In some implementations, the dynamic content slot can be filled with dynamic content items that make up the information that is presented to a user and the information that draws the user to the webpage, such as text, images, video, etc. In further implementations, the dynamic content slot can be filled with dynamic content items from one or more ad networks, such as advertisement items. In some embodiments, advertisement items that are presented in dynamic content slots can be immune to content filtering applications, as described in further detail below.

Accordingly, in various embodiments, the dynamic content slot can identify the type of dynamic website content that is to be inserted into the slot (e.g., text, video, an advertisement item, etc.) and/or can identify criteria for selecting the dynamic website content (e.g., an identifier of the website content, a category of the website content, subject matter of the website content, subject matter of other website content on the webpage, etc.).

In 230, the computing device can transmit a request for instructions on filling the dynamic content slot to a connect server (e.g., connect server 160 in FIG. 1). For example, the computing device can transmit the request via the coordinating layer of the CMS. In some embodiments, the request can include, for example, the client device information received in 210, an indication of the type of website content indicated by the dynamic content slot, a post identifier (post ID) of the dynamic content slot, and/or criteria for selecting the content.

In some embodiments, the request for instructions can include indications from the computing device on which dynamic content items to select. For example, the computing device may have previously determined which advertisements are to be inserted into the page (e.g., based on instructions from a website administrator). Thus, the request can include instructions to, for example, retrieve the specified advertisements or to transmit further instructions regarding the specified advertisements. As an additional example, the computing device may have previously determined to serve website content related to snow tires to users in Boulder, Colo. and, conversely, to serve website content related to bathing suits to users in Miami, Fla. Accordingly, in certain embodiments, the administrator can have full control over the content appearing on the webpage.

In 240, the computing device can obtain a dynamic content item in response to the request.

In some embodiments, the computing device can receive the item from the connect server. For example, the connect server can determine an item to be inserted based on one or more of the client device information, the indication of the type of website content, and the criteria, as discussed in further detail below, the connect server can retrieve the item (e.g., from a cache of the connect server, from a content server, from an ad network server, etc.), and the connect server can transmit the item to the computing device.

In some implementations, the item that is received can be an advertisement item. Moreover, in further embodiments, the connect server may have altered the size of the advertisement item so that the advertisement item is not a standard size that is identifiable by a content filter. For example, the connect server may have adjusted a length and/or a width of the advertisement item by selecting a new length and/or a new width that is less than or greater than the original length and/or width by a random number of pixels (e.g., between one and 500 pixels). Once a new length and/or a new width is selected, the connect server can, in some embodiments, scale the advertisement to the new size. In other embodiments, the connect server can generate a box that is larger than the advertisement based on the new length and/or the new width and positon the advertisement within the box without changing the size of the advertisement. For example, the generated box can be 5 pixels wider and 10 pixels longer than the advertisement, the advertisement can be positioned in the corner of the box, and the remaining area of the box can be transparent and/or layered such that the remaining area of the box would not be visible. Accordingly, the entire item (the box with the advertisement) would appear in a browser as one size (e.g., 5 pixels wider and 10 pixels longer than the advertisement), but the advertisement would appear to a viewer of the webpage as its original size.

In other embodiments, the computing device may already have the item stored locally (e.g., in a cache) or the item may be stored on a cloud server. Accordingly, the computing device can receive, from the connect server, an indication of the item to be retrieved from memory or the cloud server. For example, the connect server can determine an item to be inserted based on one or more of the client device information, the indication of the type of website content, and the criteria, as discussed in further detail below, the connect server can determine that the computing device already has the item, and the connect server can send instructions to the computing device to retrieve the item from memory or the cloud server.

In some implementations, the item that is obtained from memory or the cloud server can be an advertisement item. Moreover, in further embodiments, the connect server may instruct the computing device to alter the size of the advertisement item and/or position the advertisement item within a bigger box so that the advertisement item is not a standard size that is identifiable by a content filter, as discussed above.

In some embodiments, the item that is obtained can be a CMS theme that can be installed by the computing device, and the CMS theme can change the overall look and functionality of the webpage without altering some or all of the content of the webpage.

In 250, the computing device can cache the item if the item is not already locally stored.

In 260, the computing device can generate, using the CMS, the webpage with the item in the dynamic content slot. In some embodiments, the item can be inserted into the webpage document as actual website content using the post ID of the dynamic content slot. In other words, the dynamic content item can be inserted into the webpage document by the CMS like actual website content. Thus, the item will not be distinguishable from preexisting content and would not be identifiable by content filters. For example, code, images, text, videos, and/or hyperlinks corresponding to the item can replace the code corresponding to the dynamic content slot. As a further example, code, images, text, videos, and/or hyperlinks corresponding to the item can even replace a preexisting ad tag in the webpage. Thus, the ad tag would be removed from the webpage document and would not be identifiable by content filters, such as ad blockers. Moreover, the computing device (e.g., the website server) will have complete control over the appearance of the webpage and the ability to monitor the actual appearance of the webpage.

Additionally, in some embodiments, the computing device can record a count for the item. For example, the computing device can keep track of the number of times that a dynamic content item was added to the webpage. Additionally, the computing device can maintain a count of the number of times the dynamic content item was sent to the same computing device, the number of times the dynamic content item was sent to client devices in the same geographic area, etc. Further the computing device can record a timestamp of when the dynamic content item was added to a webpage.

The count and timestamp data can be used for selecting future dynamic content items. For example, a dynamic content item can have an impression count associated with it, such that the dynamic content item is only added to the webpage a certain number of times equal to the impression count. As an additional example, the impression count can be a number of impressions per client device, a number of impressions per geographic area, a number of impressions within a certain time block, etc. In various embodiments, once one or more impression counts are reached, the computing device may no longer use the dynamic content item and/or begin using another dynamic content item.

Once the item is added to a webpage document and the webpage is generated by the CMS, in 270, the webpage document can be transmitted to the client device that sent the initial request in 200. In various embodiments, the client device can render the webpage for display on a browser of the client device, and the dynamic item will be displayed as actual website content of the webpage. Thus, even if the browser is running a content filter, such as an ad blocker, the content filter would not be able to distinguish between the item and preexisting actual website content, and the content filter would be unable to filter out the item even if it is an advertisement.

While the steps depicted in FIG. 2 have been described as performed in a particular order, the order described is merely an example, and various different sequences of steps can be performed, consistent with certain disclosed embodiments. For example, the webpage can include multiple dynamic content slots for multiple dynamic content items, and 230-250 can be performed repeatedly (e.g., once for each dynamic content slot) or can be performed once to request instructions for all the dynamic content slots, obtain all the dynamic content items, and cache the dynamic content items, if applicable. As an additional example, client device information received in 210 can be received as a separate communication after the computing device determines that the webpage includes a dynamic content slot.

The steps described with regard to FIG. 2 are described as discrete steps merely for the purpose of explanation, and, in some embodiments, multiple steps may be performed simultaneously and/or as part of a single computation. Further, the steps described are not intended to be exhaustive or absolute, and various steps can be inserted or removed.

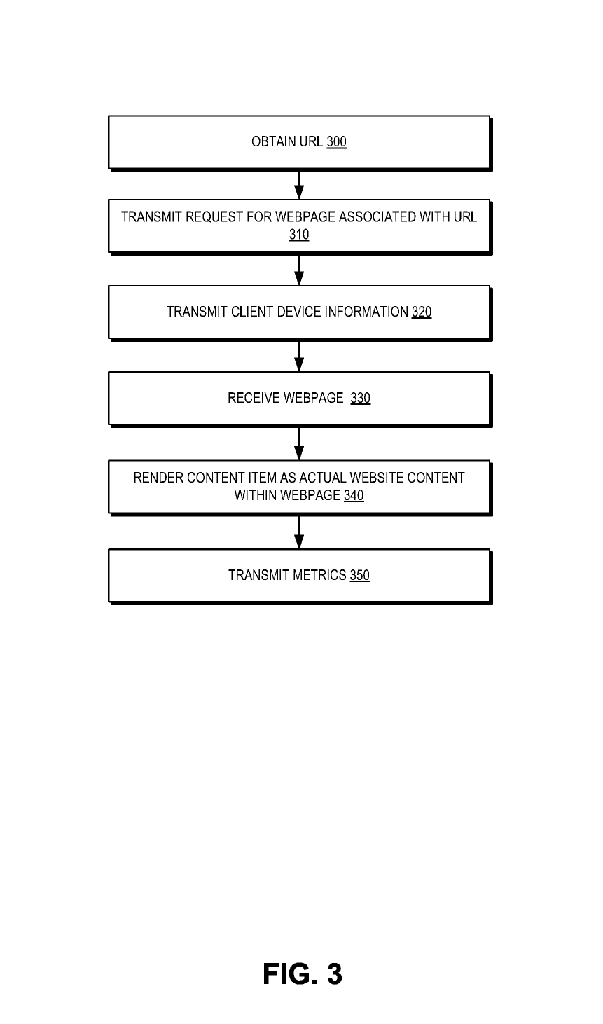

FIG. 3 is a flow diagram illustrating an example process for synchronously requesting dynamically generated webpages, consistent with certain disclosed embodiments. In some embodiments, the method described in FIG. 3 can be performed using a computing device or one or more computing devices such as, for example, a desktop computer, a laptop, a smartphone, etc. For example, the method described in FIG. 3 can be performed simultaneously or individually by one or more of client devices 120-140 in FIG. 1.

In some embodiments, the computing device can be running a web browser and a content filtering application (e.g., an ad blocker as an extension of the web browser).

The process can begin in 300, when the computing device obtains a URL via the browser. For example, a user can enter a URL into the address bar of the browser, the user can click on a hyperlink that redirects the browser using a URL, another application running on the computing device can send a URL to the browser, etc.

In 310, the computing device can transmit a request for a webpage associated with the URL obtained in 300 to a website server (e.g., website server 150 in FIG. 1). In various embodiments, the request can be an HTTP request and can include a URI that identifies a document associated with the webpage that is being requested.

In 320, the computing device can transmit client device information to the website server. For example, the client device information can include, but is not limited to, an IP address associated with the computing device, a geographic location associated with the computing device, browser cookie information of the computing device, etc.

In some embodiments, the client device information can be transmitted in the same communication as the request to access the webpage in 310, while, in further embodiments, the client device information can be transmitted as a separate communication.

In 330, the computing device can receive a webpage document associated with the URL obtained in 300.

In 340, the computing device can render the webpage for display on the browser, and the webpage can include one or more dynamic content items, which are displayed as actual website content of the webpage. Additionally, any advertisement items included in the webpage may have been altered, and, thus, may not be a standard, identifiable size. Accordingly, even if the browser is running a content filter, such as an ad blocker, the content filter would not be able to distinguish between the dynamic item(s) and preexisting actual website content, and the content filter would be unable to filter out the dynamic contents item(s) even if it was an advertisement.

In 350, the computing device can transmit metrics associated with the webpage. For example, the webpage can include a dynamic content item that replaced a dynamic content slot and/or an ad tag in the webpage when the webpage was generated by the website server. The dynamic content item can be, for example, an image and a hyperlink to a webpage of an advertiser. Accordingly, if a user clicks on the image, the user can be redirected to the webpage of the advertiser, and the click can be registered by the browser and an indication of the click can be transmitted as a metric. Additional metrics that can recorded and transmitted include, but are not limited to, revenue generated by a click, time spent on the page, URLs that were previously or subsequently visited, number of times the webpage was visited by a user, etc.

In some embodiments, the metrics can be transmitted to a connect server (e.g., connect server 160), as discussed in further detail below. In additional or alternative embodiments, the metrics can be transmitted to an ad network server.

While the steps depicted in FIG. 3 have been described as performed in a particular order, the order described is merely an example, and various different sequences of steps can be performed, consistent with certain disclosed embodiments. For example, prior to generation by the website server, the webpage may have included multiple dynamic content slots for multiple dynamic content items. Moreover, the steps are described as discrete steps merely for the purpose of explanation, and, in some embodiments, multiple steps may be performed simultaneously and/or as part of a single computation. Further, the steps described are not intended to be exhaustive or absolute, and various steps can be inserted or removed.

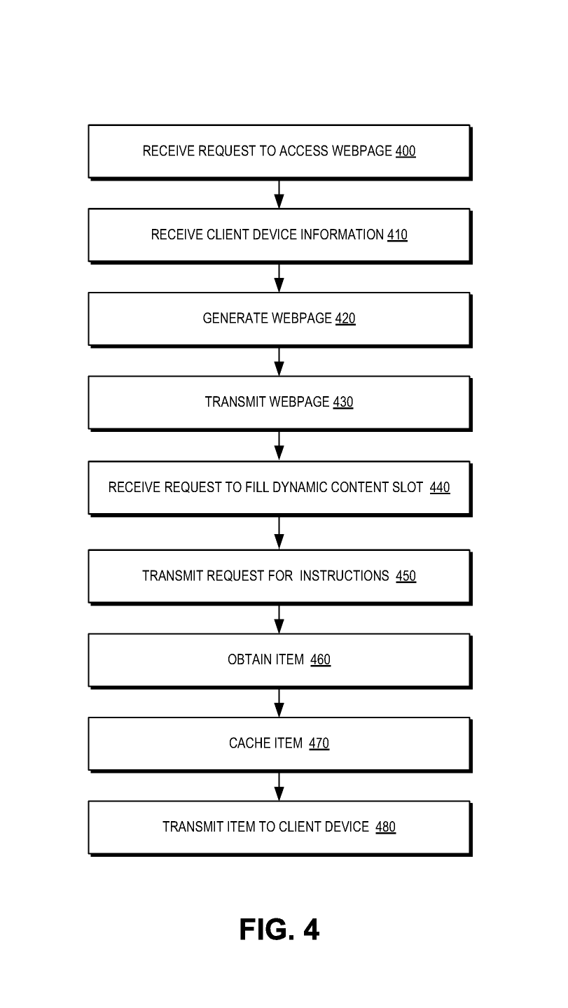

FIG. 4 is a flow diagram illustrating an example process for asynchronously providing dynamically generated webpages, consistent with certain disclosed embodiments. In some embodiments, the method described in FIG. 4 can be performed using a computing device or one or more computing devices such as, for example, a database server, a web server, a mainframe computer, etc. For example, the method described in FIG. 4 can be performed by website server 150 in FIG. 1.

In some embodiments, the computing device can be running a CMS and a coordinating layer program (e.g., as an extension and/or plug-in of the CMS).

The process can begin in 400, when the computing device receives a request to access a webpage from a client device (e.g., client device 120-140 in FIG. 1). In various embodiments, the request can be an HTTP request and can include a URI that identifies a document associated with the webpage that is being requested.

In 410, the computing device can receive client device information from the client device (e.g. client device 120-140 in FIG. 1). For example, the client device information can include, but is not limited to, an IP address associated with the client device, a geographic location associated with the client device (e.g., based on the ISP of the client device), browser cookie information of the client device (e.g., information regarding previous browsing activity of the client device), etc.

In some embodiments, the client device information can be received in the same communication as the request to access the webpage in 400, while, in further embodiments, the client device information can be received as a separate communication.

In 420, the computing device can generate, using the CMS, the webpage. In some embodiments, the webpage can include one or more dynamic content slots that are not filled. In further embodiments, the webpage can generated based on the client device information received in 410. For example, a CMS theme can be used on the webpage based on a geographic location included in the client device information. As an additional example, more or less dynamic content slots can be included in the webpage based on browser cookie information such as a number of previous visits by the client device to the webpage. As a further example, the dynamic content items that are used in the dynamic content slots can be determined based at least on the client device information, as discussed in further detail below.

In 430, once the webpage document is generated by the CMS, the webpage document can be transmitted to the client device that sent the initial request in 400.

In various embodiments, the client device can render the webpage for display on a browser of the client device, and the client device can determine that there is missing content (e.g., the dynamic content slot that has not been filled). Accordingly, the computing device can, in 440, receive an asynchronous request to fill the dynamic content slot (e.g., an asynchronous JavaScript and Extensible Markup Language (XML) communication (Ajax communication)). Because the request is asynchronous, in some embodiments, the client device may have sent the request in the background without interfering with the display and behavior of the rendered webpage.

In 450, the computing device can transmit a request for instructions on filling the dynamic content slot to a connect server (e.g., connect server 160 in FIG. 1). For example, the computing device can transmit the request via the coordinating layer. In some embodiments, the request can include, for example, the client device information received in 410, an indication of the type of website content indicated by the dynamic content slot, a post ID of the dynamic content slot, and/or criteria for selecting the website content.

In some embodiments, the request for instructions can include indications from the computing device on which dynamic content items to select, as discussed above.

In 460, the computing device can obtain a dynamic content item in response to the request.

In some embodiments, the computing device can receive the dynamic content item from the connect server, as discussed above.

In some implementations, the connect server may have altered the size of the dynamic content item (e.g., an advertisement item) or positioned the dynamic content item within a bigger box so that the dynamic content item is not a standard size that is identifiable by a content filter, as discussed above.

In other embodiments, the computing device may already have the item stored locally (e.g., in a cache) or the item may be stored on a cloud server. Accordingly, the computing device can receive, from the connect server, an indication of the item to be retrieved from memory or the cloud server.

In some implementations, the connect server may instruct the computing device to alter the size of the dynamic content item or position the dynamic content item within a bigger box so that the dynamic content item is not a standard size that is identifiable by a content filter.

In some embodiments, the item that is obtained can be a CMS theme that can be installed by the computing device, and the CMS theme can change the overall look and functionality of the webpage without altering some or all of the content of the webpage.

In 470, the computing device can cache the item if the item is not already locally stored.

In 480, the computing device can transmit an asynchronous response, using the CMS, that includes the item and instructions to fill the dynamic content slot with the item using the post ID of the dynamic content slot. Often, when a webpage is sent to a client device, one or more items may be transmitted incorrectly or may not be transmitted at all. Accordingly, client devices would send asynchronous requests for missing items. Thus, in some embodiments, the item can be transmitted by the computing device, via the CMS, similar to any actual website content that is transmitted by an asynchronous response. In other words, the dynamic content item can be transmitted by the computing device, and the browser of the client device will insert the dynamic content item into the webpage document like actual website content. Thus, the dynamic content item will not be distinguishable from preexisting actual website content and would not be identifiable by content filters. Moreover, the computing device (e.g., the website server) will have complete control over the appearance of the webpage.

Additionally, in some embodiments, the computing device can record counts and timestamps for the dynamic content item and the count and timestamp data can be used for selecting future dynamic content items, as discussed above.

While the steps depicted in FIG. 4 have been described as performed in a particular order, the order described is merely an example, and various different sequences of steps can be performed, consistent with certain disclosed embodiments. For example, the webpage can include multiple dynamic content slots for multiple dynamic content items, and 440-480 can be performed repeatedly (e.g., once for each dynamic content slot) or can be performed once when a request for all the dynamic content items is received, instructions for the dynamic content items are requested, the dynamic content items are obtained, the dynamic content items are cached, if applicable, and the dynamic content items are transmitted to the client device. As an additional example, client device information received in 410 can be received as a separate communication after the webpage is generated, after the webpage is transmitted, after one or more dynamic content items are received by the client device but before all are received, etc. Moreover, the steps are described as discrete steps merely for the purpose of explanation, and, in some embodiments, multiple steps may be performed simultaneously and/or as part of a single computation. Further, the steps described are not intended to be exhaustive or absolute, and various steps can be inserted or removed.

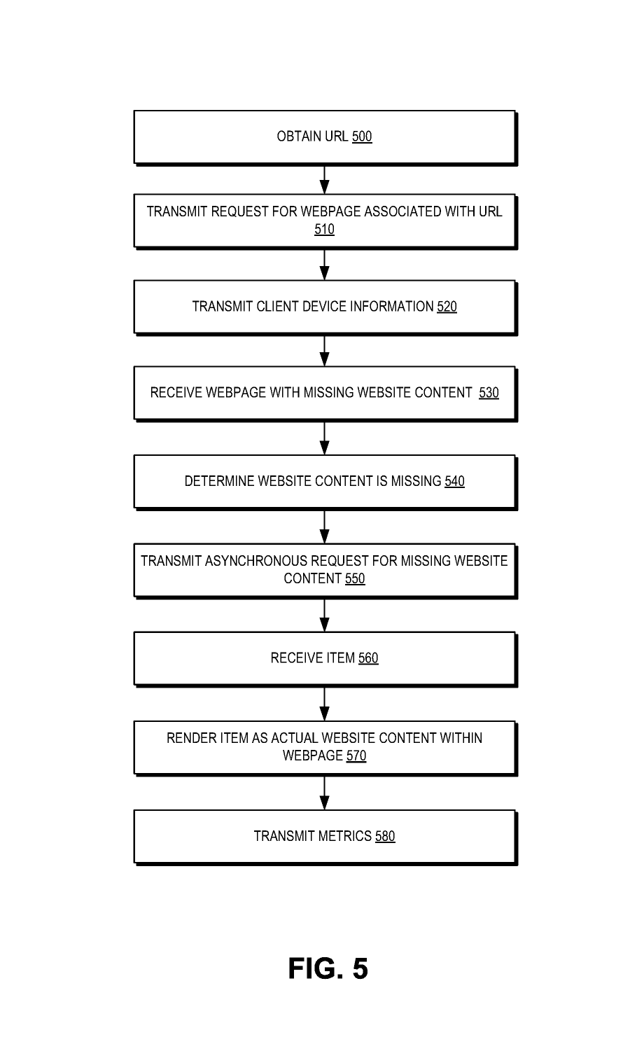

FIG. 5 is a flow diagram illustrating an example process for asynchronously requesting dynamically generated webpages and dynamic website content, consistent with certain disclosed embodiments. In some embodiments, the method described in FIG. 5 can be performed using a computing device or one or more computing devices such as, for example, a desktop computer, a laptop, a smartphone, etc. For example, the method described in FIG. 5 can be performed by one or more of client devices 120-140 in FIG. 1.

In some embodiments, the computing device can be running a web browser and a content filtering application (e.g., an ad blocker as an extension of the web browser).

The process can begin in 500, when the computing device obtains a URL via the browser. For example, a user can enter a URL into the address bar of the browser, the user can click on a hyperlink that redirects the browser using a URL, another application running on the computing device can send a URL to the browser, etc.

In 510, the computing device can transmit a request for a webpage associated with the URL obtained in 500 to a website server (e.g., website server 150 in FIG. 1). In various embodiments, the request can be an HTTP request and can include a URI that identifies a document associated with the webpage that is being requested.

In 520, the computing device can transmit client device information. For example, the client device information can include, but is not limited to, an IP address associated with the computing device, a geographic location associated with the computing device, browser cookie information of the computing device, etc.

In some embodiments, the client device information can be transmitted in the same communication as the request to access the webpage in 510, while, in further embodiments, the client device information can be transmitted as a separate communication.

In 530, the computing device can receive a webpage document associated with the URL obtained in 500. In some embodiments, the webpage document can include missing website content, such as website content associated with a dynamic content slot, as described above.

In 540, the computing device can determine website content is missing from the webpage document. Often, when a webpage is sent to a client device, one or more items may be transmitted incorrectly or may not be transmitted at all, as discussed above. Thus, the computing device can determine that website content is missing without the browser requiring special instructions or additional code.

In 550, the computing device can send an asynchronous request for the missing website content without the browser requiring special instructions or additional code. In various embodiments, the asynchronous request can include an identifier of the website content that is missing.

In 560, the computing device can receive an item via an asynchronous response from the website server. In some embodiments, the asynchronous response may have been sent via a CMS on the website server and can include instructions to add the item to the webpage. Thus, in some embodiments, the item can be received by the computing device can be actual website content and/or can be treated similar to actual website content that is received by an asynchronous response. In other words, the item, whether actual website content or a dynamic content item, can be received by the computing device, and the browser will insert the item into the webpage document as if it were actual website content. Thus, a dynamic content item would not be distinguishable from actual website content and would not be identifiable by content filters.

In 570, the computing device can render the webpage for display on the browser, and the webpage can include the item received in 560, which is displayed as actual website content of the webpage using a post ID of the dynamic content slot. Therefore, even if the browser is running a content filter, such as an ad blocker, the content filter would not be able to distinguish between a dynamic content item and actual website content, and the content filter would be unable to filter out the item even if it is an advertisement.

In 580, the computing device can transmit metrics associated with the webpage. For example, the webpage can include a dynamic content item that replaced a dynamic content slot and/or an ad tag that was originally in the webpage. The dynamic content item can be, for example, an image and a hyperlink to a webpage of an advertiser. Accordingly, if a user clicks on the image, the user can be redirected to the webpage of the advertiser, the click can be registered by the browser, and an indication of the click can be transmitted as a metric. Additional metrics that can recorded and transmitted include, but are not limited to, revenue generated by a click, time spent on the page, URLs that were previously or subsequently visited, number of times the webpage was visited by a user, etc.

In some embodiments, the metrics can be transmitted to a connect server, as discussed in further detail below. In additional or alternative embodiments, the metrics can be transmitted to an ad network server.

While the steps depicted in FIG. 5 have been described as performed in a particular order, the order described is merely an example, and various different sequences of steps can be performed, consistent with certain disclosed embodiments. For example, prior to generation by the website server, the webpage may have included multiple dynamic content slots for multiple dynamic content items. Moreover, the steps are described as discrete steps merely for the purpose of explanation, and, in some embodiments, multiple steps may be performed simultaneously and/or as part of a single computation. Further, the steps described are not intended to be exhaustive or absolute, and various steps can be inserted or removed.

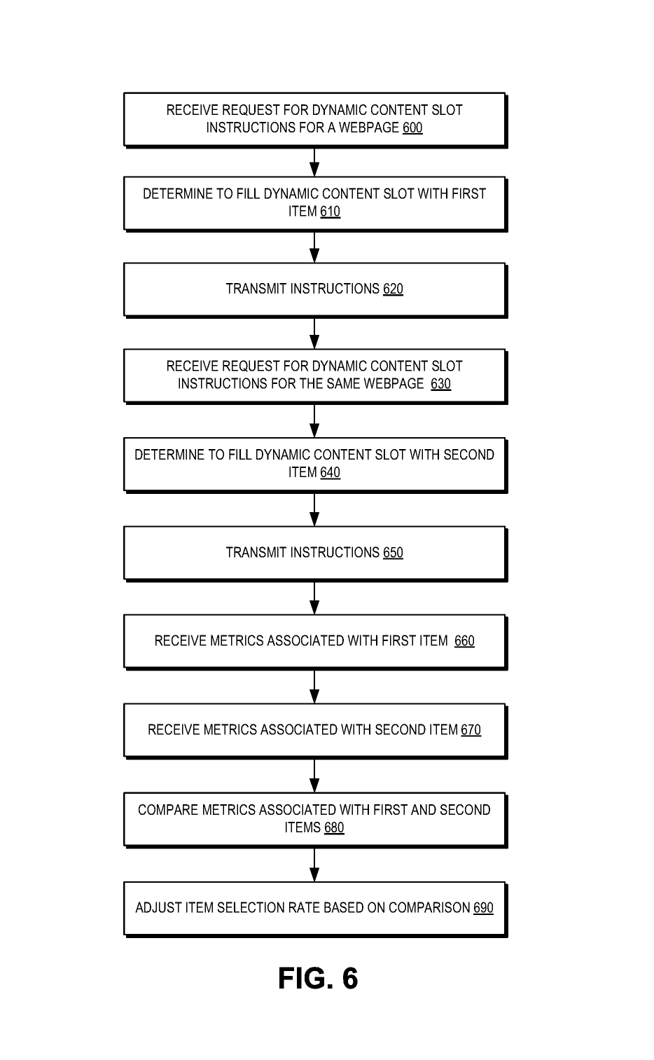

FIG. 6 is a flow diagram illustrating an example process for providing dynamic website content and comparing metrics associated with dynamic website content, consistent with certain disclosed embodiments. In some embodiments, the method described in FIG. 6 can be performed using a computing device or one or more computing devices such as, for example, a database server, a web server, a mainframe computer, etc. For example, the method described in FIG. 6 can be performed by connect server 160 in FIG. 1.

The process can begin in 600, when the computing device receives a request for dynamic content slot instructions for a webpage from a website server (e.g., from website server 150 in FIG. 1). In various embodiments, the request can include, for example, client device information of a client device requesting a webpage, an indication of a type of website content indicated by a dynamic content slot (e.g., text, video, an advertisement item, etc.), a post ID of the dynamic content slot and/or criteria for selecting the website content. In further embodiments, the request can be received via a coordinating layer of a CMS running on the website server.

In 610, the computing device can determine to fill the dynamic content slot with a first dynamic content item. In some embodiments, the computing device may have previously received instructions to compare two or more dynamic content items. Accordingly, if testing between two dynamic content items, the computing device can, in some embodiments, determine to use a dynamic content item that currently has fewer impressions (i.e., has been used to fill less dynamic content slots), can alternate between dynamic content items, can determine that the dynamic content item has not exceeded an impression count, can determine to use the dynamic content item based on an item selection rate associated with the dynamic content item, and/or can determine that a specified time block of the dynamic content item corresponds to the current time.

In some embodiments, the computing device can additionally determine to fill the dynamic content slot with the first dynamic content item based on the criteria for selecting the website content received from the website server (e.g., geographic limitations, subject matter limitations, size limitations, media type limitations, etc.).

In various embodiments, the above example can be used for dynamic content items such as text, video, images, advertisements, webpage themes, etc. Additionally, in further embodiments, the same principles could be applied to three or more dynamic content items.

In 620, the computing device can send instructions corresponding to the first dynamic content item to the website server. In some embodiments, the instructions can be for the website server to obtain the first dynamic content item (e.g., from local storage and/or a cache of the website server) and to insert the dynamic content item into the dynamic content slot (e.g., via the post ID) or to send an asynchronous response to a client device with instructions to insert the dynamic content item into the dynamic content slot. In further embodiments, the computing device can additionally or alternatively obtain and then send the first dynamic content item to the website server with the post ID. For example, the computing device can retrieve the first dynamic content item from local memory (e.g., a cache of the computing device), retrieve the first dynamic content item from a cloud server, or retrieve the first dynamic content item from a first ad network (e.g., by mimicking a browser retrieving an advertisement item via an ad tag).

In some embodiments, the instructions can further include instructions to adjust a size of the dynamic content item (e.g., an advertisement), as discussed above. Additionally or alternatively, in other embodiments, the computing device can adjust the size of the dynamic content item, as discussed above.

In further embodiments, the computing device can record counts and timestamps for the dynamic content item and the count and timestamp data can be used for selecting future dynamic content items, as discussed above.

In 630, the computing device can receive a request for dynamic content slot instructions for the same webpage from the website server (e.g., from website server 150 in FIG. 1). In various embodiments, the request can include, for example, client device information of a client device requesting the webpage, an indication of a type of website content indicated by a dynamic content slot, a post ID of the dynamic content slot, and/or criteria for selecting the webpage content. In further embodiments, the request can be received via a coordinating layer of a CMS running on the website server.

In 640, the computing device can determine to fill the dynamic content slot with a second dynamic content item. In some embodiments, the computing device may have previously received instructions to compare dynamic content items. Accordingly, if testing between two dynamic content items, the computing device can, in some embodiments, determine to use a dynamic content item that currently has fewer impressions (i.e., has been used to fill less dynamic content slots), can alternate between dynamic content items, can determine that the dynamic content item has not exceeded an impression count, can determine to use the dynamic content item based on an item selection rate associated with the dynamic content item, and/or can determine that a specified time block of the dynamic content item corresponds to the current time.

In some embodiments, the computing device can additionally determine to fill the dynamic content slot with the second dynamic content item based on the criteria for selecting the website content received from the website server (e.g., geographic limitations, subject matter limitations, size limitations, media type limitations, etc.).

In 650, the computing device can send instructions corresponding to the second dynamic content item to the website server. In some embodiments, the instructions can be for the website server to obtain the second dynamic content item (e.g., from local storage and/or a cache of the website server) and to insert the dynamic content item into the dynamic content slot or to send an asynchronous response to a client device with instructions to insert the dynamic content item into the dynamic content slot (e.g., via the post ID). In further embodiments, the computing device can additionally or alternatively obtain and then send the second dynamic content item to the website server with the post ID. For example, the computing device can retrieve the second dynamic content item from local memory (e.g., a cache of the computing device), retrieve the second dynamic content item from a cloud server, or retrieve the second dynamic content item from the first ad network or a second ad network (e.g., by mimicking a browser retrieving an advertisement item via an ad tag).

In some embodiments, the instructions can further include instructions to adjust a size of the dynamic content item (e.g., an advertisement), as discussed above. Additionally or alternatively, in other embodiments, the computing device can adjust the size of the dynamic content item, as discussed above.

In further embodiments, the computing device can record counts and timestamps for the dynamic content item and the count and timestamp data can be used for selecting future dynamic content items, as discussed above.

In various embodiments, 600-650 can be performed multiple times. In other words, multiple client devices can access the webpage with the first dynamic content item and multiple client devices can access the webpage with the second dynamic content item.

In 660, the computing device can receive metrics associated with the first dynamic content item. For example, the first dynamic content item can be an image and a hyperlink to a webpage of an advertiser. Accordingly, if a user of a client device that rendered the webpage with the first dynamic content item clicks on the image, the user can be redirected to the webpage of the advertiser, the click can be registered by the browser of the client device, and an indication of the click can be transmitted as a metric and received by the computing device. Additional metrics that can recorded and transmitted include, but are not limited to, revenue generated by a click, time spent on the page, URLs that were previously or subsequently visited, number of times the webpage was visited by a user, etc.

In various embodiments, metrics can be received from multiple client devices that received the first dynamic content item.

In 670, the computing device can receive metrics associated with the second dynamic content item. For example, the second dynamic content item can be an image and a hyperlink to a webpage of an advertiser. Accordingly, if a user of a client device that rendered the webpage with the second dynamic content item clicks on the image, the user can be redirected to the webpage of the advertiser, the click can be registered by the browser of the client device, and an indication of the click can be transmitted as a metric and received by the computing device. Additional metrics that can recorded and transmitted by the computing device, as discussed above.

In various embodiments, metrics can be received from multiple client devices that received the second dynamic content item.

In 680, the computing device can compare metrics associated with the first dynamic content item to metrics associated with the second dynamic content item. For example, the computing device can determine which dynamic content item resulted in more user clicks, which dynamic content item resulted in increased revenue, which dynamic content item resulted in more time spent on the page, which dynamic content item resulted in a higher click-through-rate, which dynamic content item resulted in repeat visitors, etc.

In some embodiments, the metrics can additionally or alternatively be sent to one or more third-party website analytic providers. For example, the metrics can be sent to two different third-party website analytic providers to determine additional metrics that can be used to compare the first dynamic content item to the second dynamic content item.

In 690, the computing device can use the comparison to determine an item selection rate for the dynamic content items. For example, if the computing device determined that the first dynamic content item resulted in more clicks, resulted in increased revenue, resulted in more average time spent on the page, resulted in a higher click-through-rate, resulted in repeat visitors, etc., the computing device can change an item selection rate of the first and the second dynamic content items such that the first dynamic content item is sent to more client devices than the second dynamic content item.

In various embodiments, the above example can be used for dynamic content items such as text, video, images, advertisements, webpage themes, etc. For example, webpage themes that resulted in longer viewer engagement (i.e., longer time spent on the webpage) can result in a positive change to the item selection rate compared to webpage themes that resulted in shorter viewer engagement. Additionally, in further embodiments, the same principles could be applied to three or more dynamic content items, etc.

While the steps depicted in FIG. 6 have been described as performed in a particular order, the order described is merely an example, and various different sequences of steps can be performed, consistent with certain disclosed embodiments. Moreover, the steps are described as discrete steps merely for the purpose of explanation, and, in some embodiments, multiple steps may be performed simultaneously and/or as part of a single computation. Further, the steps described are not intended to be exhaustive or absolute, and various steps can be inserted or removed.

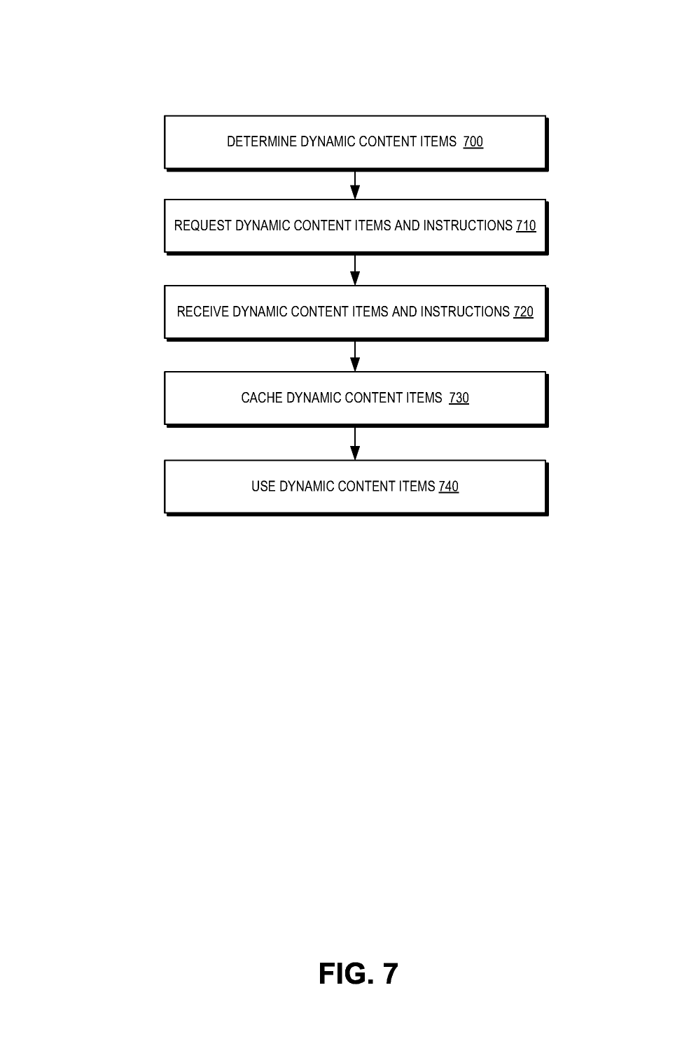

FIG. 7 is a flow diagram illustrating an example process for dynamic content caching at a website server, consistent with certain disclosed embodiments. In some embodiments, the method described in FIG. 7 can be performed using a computing device or one or more computing devices such as, for example, a database server, a web server, a mainframe computer, etc. For example, the method described in FIG. 7 can be performed by website server 150 in FIG. 1.

In some embodiments, the computing device can be running a CMS and a coordinating layer program (e.g., as an extension of the CMS).

The process can begin in 700, when the computing device determines one or more dynamic content items to use for one or more webpages. In some embodiments, the dynamic content items can be advertisements and the advertisements can be selected manually by an operator from a listing of advertisements available from one or more ad networks. In other embodiments, the dynamic content items can be selected automatically by the computing device based on, for example, subject matter of the one or more webpages, criteria specified by an operator, etc.

In 710, the computing device can transmit a request for the determined dynamic content items and instructions associated with using the dynamic content items (i.e., instructions on filling dynamic content slots) to a connect server (e.g., connect server 160 in FIG. 1). For example, the computing device can transmit the request via the coordinating layer. In some embodiments, the request can include, for example, identifiers of the determined dynamic content items, post IDs of dynamic content slots in the webpages, and/or criteria for selecting the dynamic content items.

In 720, the computing device can receive the dynamic content items and instructions associated with using the dynamic content items (e.g., instructions on altering the size of a dynamic content item) in response to the request.

In 730, the computing device can cache the received dynamic content items with the instructions.

In 740, based on a request for one of the webpages, the computing device can use a cached dynamic content item to fill in a dynamic content slot of the webpage based on the instructions. For example, the computing device can generate the webpage with the cached dynamic content item, as discussed with regard to FIG. 2. Alternatively, for example, the computing device can receive an asynchronous request to fill a dynamic content slot and transmit the cached dynamic content item in an asynchronous response, as discussed with regard to FIG. 4.

Accordingly, the computing device is able to respond to HTTP requests for webpages by providing webpages with dynamic content using cached and, in some embodiments, varied dynamic content items. In various embodiments, this can provide the technical benefit of allowing the computing device to respond HTTP requests with dynamic website content while avoiding potential delays and/or latency caused by requested the dynamic content items (e.g., advertisements) from ad networks (e.g., via a connect server).

In some embodiments, the above example can be used for dynamic content items such as text, video, images, advertisements, webpage themes, etc.

While the steps depicted in FIG. 7 have been described as performed in a particular order, the order described is merely an example, and various different sequences of steps can be performed, consistent with certain disclosed embodiments. Moreover, the steps are described as discrete steps merely for the purpose of explanation, and, in some embodiments, multiple steps may be performed simultaneously and/or as part of a single computation. Further, the steps described are not intended to be exhaustive or absolute, and various steps can be inserted or removed.

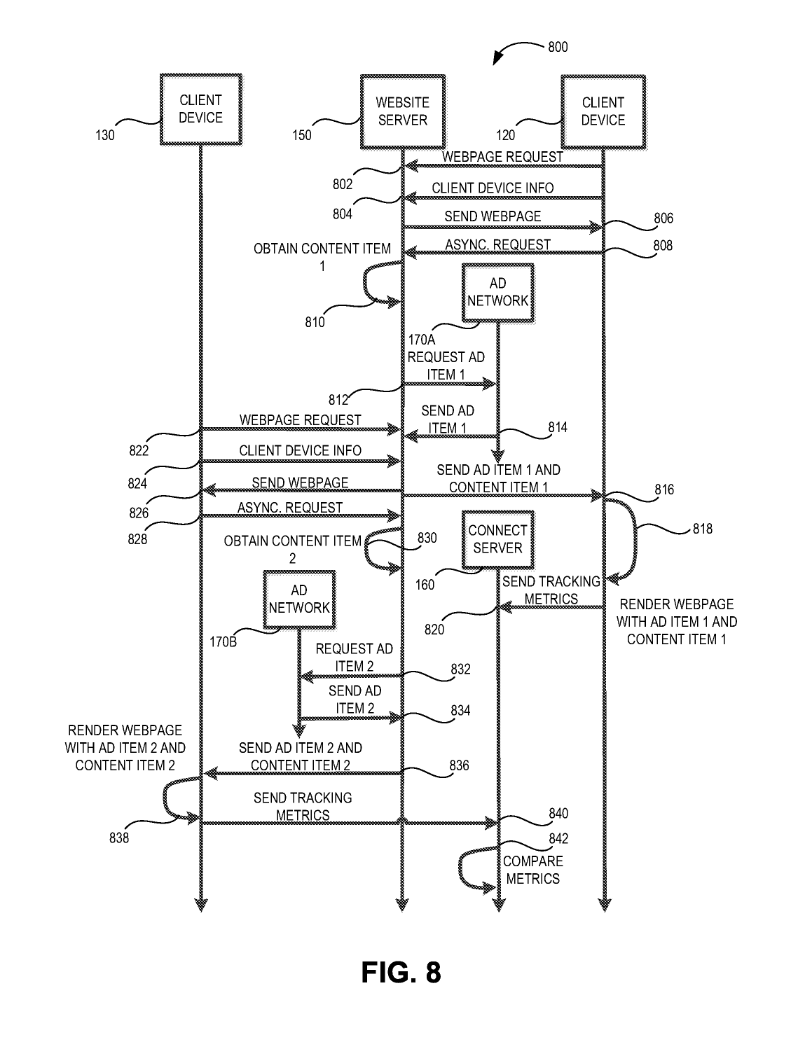

FIG. 8 is a flow diagram illustrating example communications in a webpage distribution network, consistent with certain disclosed embodiments. As shown in FIG. 8, webpage distribution network 800 can include client device 120, client device 130, website server 150, connect server 160, ad network server 170A, and ad network server 170B.

The process can begin in 802, when client device 120 sends a webpage request to website server 150 and sends client device information associated with client device 120 in 804. Based on the webpage request and the client device information, in 806, website server 150 can send a webpage with one or more dynamic content slots, such as, for example, at least two dynamic content slots.

In 808, client device 120 can send an asynchronous request to website server 150 for website content associated with the at least two dynamic content slots based on determining that at least two items are missing from the received webpage.

The website server can determine that at least one of the dynamic content slots is associated with a content item that is not an advertisement (e.g., textual content, video content, image content, a webpage theme, etc.) and at least one of the dynamic content slots is associated with an advertisement item. Additionally, the website server can request instructions from connect server 160 corresponding to the dynamic content slots (communication not shown).

In 810, based on instructions received from connect server 160 (not shown) website server can obtain content item 1 from local storage. Content item 1 can be associated with a first dynamic content slot.

In 812, based on instructions received from connect server 160 (communication not shown) website server 150 can request advertisement item 1 from ad network server 170A and, in 814, website server 150 can receive advertisement item 1 from ad network server 170A. Advertisement item 1 can be associated with a second dynamic content slot. In alternative embodiments (not shown), connect server 160 may request advertisement item 1 from ad network server 170A, receive advertisement item 1 from ad network server 170A, and transmit advertisement item 1 to website server 150.

In 816, website server 150 can send content item 1 and advertisement item 1 to client device 120 via an asynchronous response, and client device 120 can, in 818, render the webpage with advertisement item 1 and content item 1 as actual website content of the webpage. Additionally, in 820, client device 120 can send tracking metrics to connect server 160.

In 822, client device 130 can send a webpage request to website server 150 and send client device information associated with client device 130 in 824. Based on the webpage request and the client device information, in 826, website server 150 can send a webpage with one or more dynamic content slots, such as, for example, at least two dynamic content slots.

In 828, client device 120 can send an asynchronous request to website server 150 for website content associated with the at least two dynamic content slots based on determining that at least two items are missing from the received webpage.

The website server can determine that at least one of the dynamic content slots is associated with a content item that is not an advertisement and at least one of the dynamic content slots is associated with an advertisement item. Additionally, the website server can request instructions from connect server 160 corresponding to the dynamic content slots (communication not shown).

In 830, based on instructions received from connect server 160 (communication not shown) website server 150 can obtain content item 2 from local storage. Content item 2 can be associated with a first dynamic content slot.

In 832, based on instructions received from connect server 160 (not shown) website server 150 can request advertisement item 2 from ad network server 170B and, in 834, website server 150 can receive advertisement item 2 from ad network server 170B. Advertisement item 2 can be associated with a second dynamic content slot. In alternative embodiments (not shown), connect server 160 may request advertisement item 2 from ad network server 170B, receive advertisement item 2 from ad network server 170B, and transmit advertisement item 2 to website server 150.

In 836, website server 150 can send content item 2 and advertisement item 2 to client device 130 via an asynchronous response, and client device 130 can, in 838, render the webpage with advertisement item 2 and content item 2 as actual website content of the webpage. Additionally, in 840, client device 130 can send tracking metrics to connect server 160.

Accordingly, although client device 120 and client device 130 requested the same webpage, the webpages that are rendered by the client devices include different dynamic content items, and the dynamic content items appear as actual website content of the website and cannot be filtered by content filtering applications, such as ad blocking browser extensions.

Additionally, 842, connect server 160 can compare the metrics received from client device 120 and client device 130 and determine which dynamic content items produced better metrics, as described above.

The steps described with regard to FIG. 8 are merely a simple example of communications that can occur in a webpage distribution network. Accordingly, additional, fewer, and/or different communications can occur, consistent with disclosed embodiments. Additionally, while the above example describes using two dynamic content slots, other embodiments can use additional or fewer dynamic content slots, consistent with disclosed embodiments. Moreover, while the steps depicted in FIG. 8 have been described as performed in a particular order, the order described is merely an example, and various different sequences of steps can be performed, consistent with certain disclosed embodiments. Further, the steps are described as discrete steps merely for the purpose of explanation, and, in some embodiments, multiple steps may be performed simultaneously and/or as part of a single computation. Additionally, the steps described are not intended to be exhaustive or absolute, and various steps can be inserted or removed.

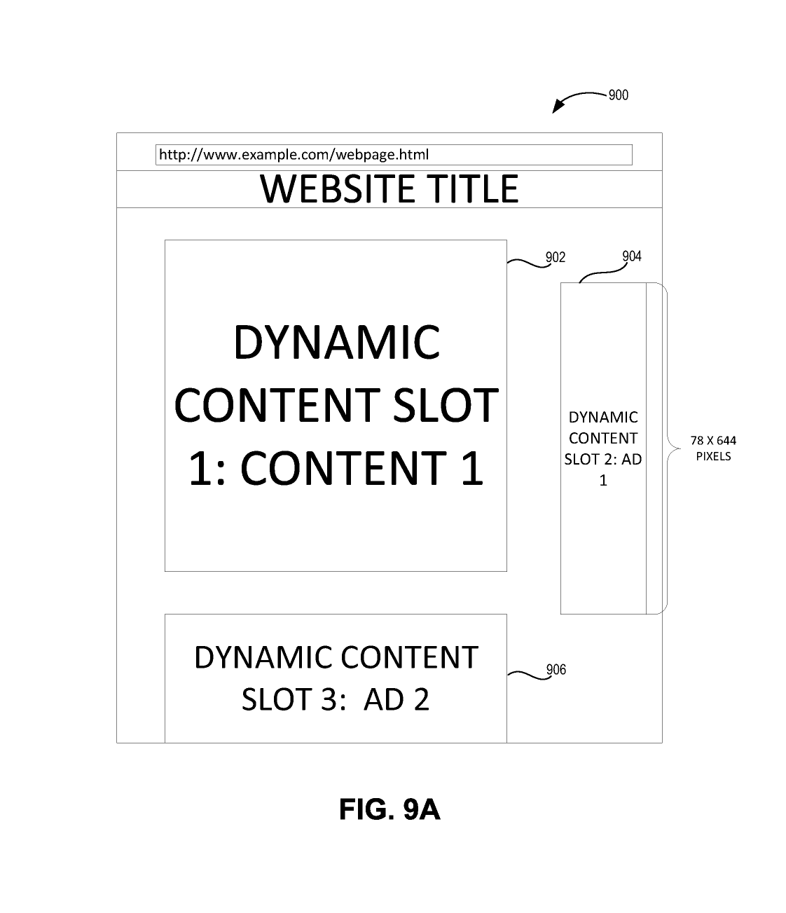

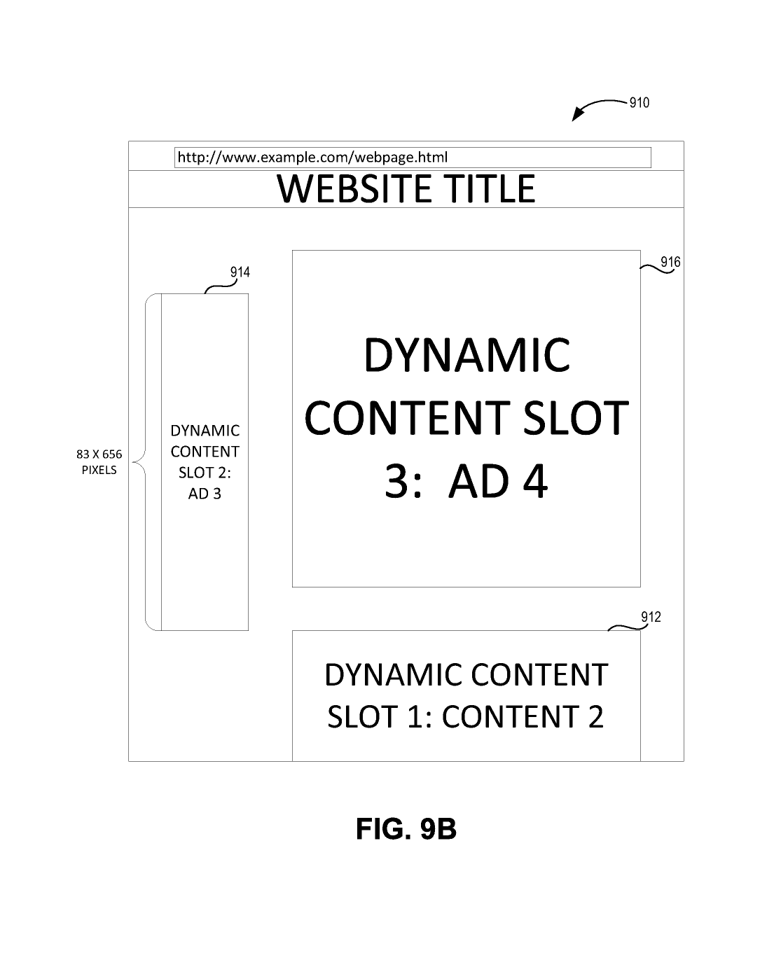

FIG. 9A is a diagram illustrating an example webpage generated using dynamic content slots, consistent with certain disclosed embodiments. As shown in FIG. 9A, webpage 900 includes three dynamic content slots 902, 904, and 906. Additionally, webpage 900 may have been generated using a first webpage theme and may be associated with the URL www.example.com/webpage.html.

As discussed above, a client device (e.g., client device 120-140) may have requested a webpage from a website server (e.g., website server 150) and the website server may have determined that there were dynamic content slots in the webpage. The website server may have requested instructions from a connect server (e.g., connect server 160 in FIG. 1 or FIG. 8) and received instructions and/or dynamic content items. The instructions may have also included instructions to use a first webpage theme and instructions to adjust the size of dynamic content slot 2 (904) to, for example, 78 by 644 pixels, which can be randomly generated values as discussed above. The website server may have generated the webpage by filling in the dynamic content items and formatting the webpage using the first webpage theme and the sizing instructions.

As shown in FIG. 9A, dynamic content slot 1 (902) may include content item 1, dynamic content slot 2 (904) may include advertisement 1 at, for example, the size of 78 by 644 pixels, and dynamic content slot 3 (906) may include advertisement 2.

The example webpage shown in FIG. 9A is merely a simplified example of a webpage, and is not intended to be limiting.

FIG. 9B is a diagram illustrating an example webpage generated using dynamic content slots, consistent with certain disclosed embodiments. As shown in FIG. 9B, webpage 910 includes three dynamic content slots 912, 914, and 916. Additionally, the webpage of FIG. 9B may have been generated using a second webpage theme and webpage 910 may be associated with the same URL as webpage 900, www.example.com/webpage.html, where the second webpage theme is different than the first webpage theme of webpage 900.

As discussed above, a client device (e.g., client device 120-140) may have requested a webpage from a website server (e.g., website server 150) and the website server may have determined that there were dynamic content slots in the webpage. The website server may have requested instructions from a connect server (e.g., connect server 160 in FIG. 1 or FIG. 8) and receive instructions and/or dynamic content items. The instructions may have also included instructions to use a second webpage theme and instructions to adjust the size of dynamic content slot 2 (914) to, for example, 83 by 656 pixels, which can be randomly generated values as discussed above. The website server may have generated the webpage by filling in the dynamic content items and formatting the webpage using the second webpage theme and the sizing instructions.

As shown in FIG. 9B, the dynamic content slot 1 (912) may include content item 2, dynamic content slot 2 (914) may include advertisement 3 at a size of, for example, 83 by 656 pixels, and dynamic content slot 3 (916) may include advertisement 4.

The example webpage shown in FIG. 9B is merely a simplified example of a webpage, and is not intended to be limiting.

Thus, even though webpage 900 and webpage 910 are associated with the same URL, the presentation of the webpage can be different by, for example, including different dynamic content items and/or positioning the dynamic content slots in different locations. Additionally, because the dynamic content items are sent as actual website content, are not in expected advertisement sizes, and/or are placed in locations usually reserved for content, the dynamic content items would not be identified and filtered by content filtering applications, such as ad blocking extensions.

Although FIGS. 9A and 9B depict positioning dynamic content slots at different locations based on using different webpages themes, in other example embodiments the webpages could position the dynamic content slots in the same location. For example, different instances of the webpage can use the same webpage theme. Thus, even though dynamic content within the dynamic content slots may have changed, the positions may not have.

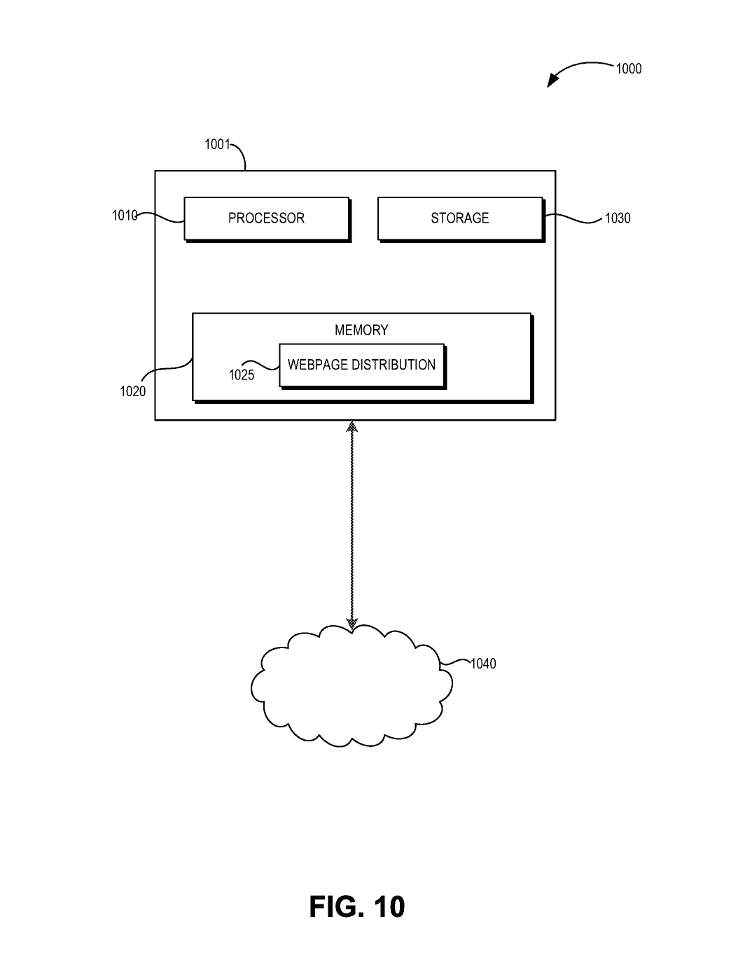

FIG. 10 is a diagram illustrating an example of a hardware system that can be used in a webpage distribution network, consistent with certain disclosed embodiments. An example hardware system 1000 includes example system components that may be used. The components and arrangement, however, may be varied.

Computer 1001 may include processor 1010, memory 1020, storage 1030, and input/output (I/O) devices (not pictured). The computer 1001 may be implemented in various ways and can be configured to perform any of the embodiments described above. In some embodiments, computer 1001 can be a computer of an end user such as, for example, a desktop computer, a laptop, a tablet device, a mobile device (e.g., a smartphone), etc. In other embodiments, computer 1001 can be a computing device such as, for example, a database server, a web server, a mainframe computer, etc. For example, computer 1001 can be client devices 120, 130, and 140, website server 150, and/or connect server 160 in FIGS. 1 and 8. Computer 1001 may be standalone or may be part of a subsystem, which may, in turn, be part of a larger system.

The processor 1010 may include one or more known processing devices, such as a microprocessor from the Intel Core™ family manufactured by Intel™, the Phenom™ family manufactured by AMD™, or the like. Memory 1020 may include one or more storage devices configured to store information and/or instructions used by processor 1010 to perform certain functions and operations related to the disclosed embodiments. Storage 1030 may include a volatile or non-volatile, magnetic, semiconductor, tape, optical, removable, non-removable, or other type of computer-readable medium used as a storage device. In some embodiments, storage 1030 can include, for example, webpage documents, browsers programs, content filtering applications, CMS programs, coordinating layer programs, etc.

In an embodiment, memory 1020 may include one or more programs or subprograms including instructions that may be loaded from storage 1030 or elsewhere that, when executed by computer 1001, perform various procedures, operations, or processes consistent with disclosed embodiments. For example, memory 1020 may include webpage distribution program 1025 for requesting and rendering webpages synchronously or asynchronously (e.g., a browser), generating and/or providing webpages synchronously or asynchronously (e.g., a CMS), enabling communications between a website server and a connect server (e.g., a coordinating layer program), providing dynamic website content, or comparing metrics associated with dynamic website content, according to various disclosed embodiments. Memory 1020 may also include other programs that perform other functions, operations, and processes, such as programs that provide communication support, Internet access, etc. The webpage distribution program 1025 may be embodied as a single program, or alternatively, may include multiple sub-programs that, when executed, operate together to perform the function of the webpage distribution program 1025 according to disclosed embodiments. In some embodiments, webpage distribution program 1025 can perform all or part of the processes of FIGS. 2-8, described above.

Computer 1001 may communicate over a link with network 1040. For example, the link may be a direct communication link, a local area network (LAN), a wide area network (WAN), or other suitable connection. Network 1040 may include the internet, as well as other networks, which may be connected to various systems and devices.

Computer 1001 may include one or more input/output (I/O) devices (not pictured) that allow data to be received and/or transmitted by computer 1001. I/O devices may also include one or more digital and/or analog communication I/O devices that allow computer 1001 to communicate with other machines and devices. I/O devices may also include input devices such as a keyboard or a mouse, and may include output devices such as a display or a printer. Computer 1001 may receive data from external machines and devices and output data to external machines and devices via I/O devices. The configuration and number of input and/or output devices incorporated in I/O devices may vary as appropriate for various embodiments.

Example uses of the system 1000 can be described by way of example with reference to the embodiments described above.

While the teachings has been described with reference to the example embodiments, those skilled in the art will be able to make various modifications to the described embodiments without departing from the true spirit and scope. The terms and descriptions used herein are set forth by way of illustration only and are not meant as limitations. In particular, although the method has been described by examples, the steps of the method may be performed in a different order than illustrated or simultaneously. Furthermore, to the extent that the terms “including”, “includes”, “having”, “has”, “with”, or variants thereof are used in either the detailed description and the claims, such terms are intended to be inclusive in a manner similar to the term “comprising.” As used herein, the term “one or more of” with respect to a listing of items such as, for example, A and B, means A alone, B alone, or A and B. Those skilled in the art will recognize that these and other variations are possible within the spirit and scope as defined in the following claims and their equivalents.

What is claimed is:

1. A system for providing dynamic website content, comprising:
a processing system comprising one or more processors; and
a memory system comprising one or more computer-readable media, wherein the one or more computer-readable media contain instructions that, when executed by the processing system, cause the processing system to perform operations comprising:
receiving, from a client device, a request to access a webpage associated with an address, the request comprising client device information;
generating the webpage with a dynamic content slot based on the client device information;
transmitting the webpage to the client device;
receiving an asynchronous request to fill the dynamic content slot based on a determination by the client device that the webpage was missing an item;
transmitting a request for instructions associated with the dynamic content slot;
obtaining an item in response to the request for instructions; and
transmitting the item to the client device.

2. The system of claim 1, wherein the item is a content item comprising one or more of textual data, video data, or image data.

3. The system of claim 1, wherein the item is a CMS theme.

4. The system of claim 1, whereby:
the client device renders, in a browser, website content within the webpage comprising the item in the dynamic content slot; and
whereby the browser identifies the item as actual website content of the webpage

5. The system of claim 4, wherein the item is an advertisement item.

6. The system of claim 5, the operations further comprising adjusting a size of the advertisement item to a size that is renderable in the browser as a size that is different from an original size of the advertisement item.

7. The system of claim 6, wherein adjusting the size of the advertisement item comprises increasing or decreasing at least one of a width or a height of the advertisement item by a random number of pixels.

8. The system of claim 1, wherein the client device information comprises one or more of an Internet Protocol (IP) address of the client device, geographic information associated with the client device, or browser cookie information associated with the client device.

9. The system of claim 1, wherein the client device is running an ad blocker application, and the ad blocker application allows the item to be displayed based on a browser identifying the item as actual website content of the webpage.

10. The system of claim 1, the operations further comprising:
determining one or more dynamic content items for use in the webpage;
transmitting a request for the one or more dynamic content items and for instructions associated with the one or more dynamic content items;
receiving the one or more dynamic content items and instructions associated with the one or more dynamic content items; and
storing the one or more dynamic content items and instructions associated with the one or more dynamic content items in a cache;
wherein obtaining a website content item in response to the request comprises retrieving a dynamic content item of the one or more dynamic content items from the cache; and
wherein transmitting the website content item to the client device comprises transmitting the website content item based on instructions associated with the dynamic content item.

11. The system of claim 1, wherein transmitting the item to the client device comprises transmitting the item with a post identifier of the dynamic content slot, whereby the item is renderable by the client device using the post identifier.

12. A system for providing dynamic website content, comprising:
a processing system comprising one or more processors; and
a memory system comprising one or more computer-readable media, wherein the one or more computer-readable media contain instructions that, when executed by the processing system, cause the processing system to perform operations comprising:
receiving, from a website server, a first request for instructions associated with a dynamic content slot associated with a webpage;
determining to fill the dynamic content slot with a first item;
transmitting instructions corresponding to the first item to the website server whereby the website server transmits a webpage to a first client device, the first client device renders, in a browser, website content within the webpage comprising the first item in the dynamic content slot, and the browser identifies the first item as actual website content of the webpage.
receiving, from the website server, a second request for instructions associated with the dynamic content slot associated with the webpage;
determining to fill the dynamic content slot with a second item;
transmitting instructions corresponding to the second item to the website server whereby the website server transmits a webpage to a second client device, the second client device renders, in a browser, website content within the webpage comprising the second item in the dynamic content slot, and the browser identifies the second item as actual website content of the webpage.

13. The system of claim 12, the operations further comprising:
receiving metrics associated with the first item from the first client device;
receiving metrics associated with the second item from the second client device; and
comparing the metrics associated with the first item to the metrics associated with the second item.

14. The system of claim 13, the operations further comprising adjusting an item selection rate based on comparing the metrics.

15. The system of claim 14, wherein adjusting the item selection rate comprises adjusting the item selection rate based on metrics of the first item, the second item, or both, the metrics comprising at least one of a number of clicks, a revenue associated with the item, an average time spent on the page, a click-through-rate, or a number of repeat visitors.

16. The system of claim 12, wherein the item is a content item comprising one or more of textual data, video data, or image data.

17. The system of claim 12, wherein the item is an advertisement item.

18. The system of claim 17, the operations further comprising adjusting a size of the advertisement item, whereby the advertisement item is rendered in the browser as a size that is different from an original size of the advertisement item.

19. The system of claim 18, wherein adjusting the size of the advertisement item comprises increasing or decreasing at least one of a width or a height of the advertisement item by a random number of pixels.

20. The system of claim 12, wherein the first request, the second request, or both comprise client device information, the client device information comprising one or more of an Internet Protocol (IP) address of the client device, geographic information associated with the client device, or browser cookie information associated with the client device.

21. The system of claim 12, wherein the first client device, the second client device, or both are running an ad blocker application, and the ad blocker application allows the item to be displayed based on a browser identifying the item as actual website content of the webpage.

22. The system of claim 12, the operations further comprising:
receiving, from the website server, a request for one or more dynamic content items and for instructions associated with the one or more dynamic content items;
obtaining the one or more dynamic content items from one or more ad networks; and
transmitting, to the website server, the one or more dynamic content items and instructions associated with the one or more dynamic content items, wherein the website server stores the one or more dynamic content items and instructions associated with the one or more dynamic content items in a cache.

23. The system of claim 12, wherein the first request comprises a post identifier of the dynamic content slot and transmitting the instructions corresponding to the first item comprises transmitting the post identifier, whereby the first client device renders the first item using the post identifier.

24. A system for providing dynamic website content, comprising:
a processing system comprising one or more processors; and
a memory system comprising one or more computer-readable media, wherein the one or more computer-readable media contain instructions that, when executed by the processing system, cause the processing system to perform operations comprising:
receiving, from a user browser, a request to access a webpage associated with an address;
coordinating with a connect server to determine a least one item based on user browser information corresponding to the user browser;
generating the webpage with the at least one item; and
transmitting the webpage to the client device, wherein the at least one item is served as actual website content of the webpage;
